(19) United States
(12) Patent Application Publication
(10) Pub. No.: US 2025/0313447 A1
(43) Pub. Date: Oct. 9, 2025

(54) DISPENSING DEVICE FOR A CONTAINER OF LIQUIDS AND RELATIVE TRANSFER SYSTEM

(71) Applicant: Luca Pietro FESTA, Lumezzane (IT)

(72) Inventor: Luca Pietro FESTA, Lumezzane (IT)

(21) Appl. No.: 18/847,434

(22) PCT Filed: Feb. 22, 2023
(86) PCT No.: PCT/IT2023/050057

§ 371 Date: Sep. 16, 2024

(30) Foreign Application Priority Data
Mar. 14, 2022 (IT) 102022000004910

(51) Int. Cl. B67D 1/04

(52) U.S. Cl. CPC B67D 1/0412

(57) ABSTRACT

Dispensing device (100) for a container (90; 92) of liquids, comprising:—a main body (1) provided with an inner surface (7) which defines a through housing seat (10) from a first (11) to a second mouth (12) of the main body (1) arranged along a longitudinal axis (300);—an adapter (2) coupled to the main body (1) at the first mouth (11), and shaped to couple with a mouth of the container (90);—a tubular body (3) housed in the housing seat (10) and internally defining a transfer duct (4) which puts in fluid communication the first (11) and second mouth (12):—a pressurization duct (5) which puts in fluid communication the first mouth (11) with a pressurization opening (6) obtained in the main body (1) and jutting into an external environment (150) from the dispensing device (100), wherein said pressurization duct (5) is part of said housing seat (10) and is defined by an outer surface (8) of the tubular body (3) and by the inner surface (7) of the main body (1).

### TECHNICAL FIELD OF THE INVENTION

The present invention concerns a dispensing device for a container of liquids and a relative transfer system (tapping and/or filling) comprising this dispensing device.

### BACKGROUND ART

Systems for tapping beverages (for example water, wine or, more typically, carbonated beverages, such as for example beer or carbonated beverages) from containers (e.g., a drum, a barrel or a bottle) are known.

For example, documents DE3540984A1, U.S. Pat. Nos. 2,638,914A, and 3,843,172A describe tapping systems comprising a dispensing device structured to sealingly couple with a mouth of the container to allow tapping the beverage through a duct which draws from the bottom of the container and passes through the dispensing device to connect to a delivery line which terminates at a tapping tap. Typically a gas, such as carbon dioxide (CO₂) or nitrogen (N₂), is introduced (through a further dedicated duct passing through the dispensing device) inside the container to pressurize the liquid, so as to push the pressurized liquid into the duct and from there, via the delivery line, up to the tapping tap. The manual opening of the tapping tap allows the delivery of the liquid to fill, for example, a bottle or a glass.

### SUMMARY OF THE INVENTION

In this context, the Applicant made the following considerations and identified the following problems.

The Applicant believes that the known dispensing devices for tapping systems are large-sized and/or have an excessively complex structure, which entails disadvantages in terms of one or more among: the space occupied by the device (and therefore by the overall transfer system), high costs and/or production times and/or assembly of the device, high risk of breakage of the device (or at least some of the components thereof). In particular, the Applicant believes that the above problems are particularly important if the dispensing devices are used for domestic use, i.e. in private homes, and/or in small bars/pubs and/or aggregation facilities including a refreshment point, such as for example sports centres, etc., where the economic and/or space availability is typically limited.

The Applicant has therefore dealt with the problem of realizing a dispensing device for a container of liquids for use in tapping and/or filling systems, which has reduced dimensions and/or limited cost (e.g. which can be realized in a simple and/or rapid way) and/or is reliable as to failure.

According to the Applicant, the above problem is solved by a dispensing device for a container of liquids in accordance with the attached claims and/or having one or more of the following characteristics.

According to one aspect, the invention concerns a dispensing device for a container of liquids, wherein said dispensing device comprises:
a main body provided with an inner surface which defines a through housing seat from a first to a second mouth of the main body arranged along a longitudinal axis;
an adapter coupled to said main body at the first mouth of said main body, and shaped to couple (sealingly) with a mouth of said container;
a tubular body (removably) housed in said housing seat and internally defining a transfer duct which puts in fluid communication said first and said second mouth of the main body;
a pressurization duct which puts in fluid communication the first mouth with a pressurization opening obtained in the main body and jutting into an external environment to the dispensing device,
   wherein said pressurization duct is part of said housing seat and is defined by an outer surface of the tubular body and by said inner surface of the main body.

By “longitudinal”, “lengthwise”, and the like it is meant a direction parallel to said longitudinal axis.

By “transverse”, “transversely”, and the like it is meant a direction perpendicular to said longitudinal axis. By “radial” it is meant a transversal direction passing through said longitudinal axis.

According to the Applicant, the adapter allows to couple the entire dispensing device to the mouth of the container, so that the device seals off (except for the ducts) an environment inside the container from an environment outside the container, where the first mouth of the main body faces the internal environment of the container.

The pressurization duct (which develops, with at least one longitudinal component, from the first mouth to the pressurization opening) allows the passage of gas between the environment outside the container (through the pressurization opening obtained in the main body and distinct from the second mouth of the main body) and the environment inside the container (through the first mouth). Similarly, the transfer duct allows the passage of liquid between the environment outside the container (through the second mouth of the main body) and the environment inside the container (through the first mouth of the main body and a lower mouth of the tubular body).

According to the Applicant, the pressurization duct defined directly by the outer surface of the tubular body, on the one hand, and by the inner surface of the housing seat, on the other hand, i.e. obtained by transversal oversizing of the housing seat with respect to the tubular body, is made by exploiting the structural elements of the dispensing device (i.e., the tubular body and its housing seat itself). This allows, on the one hand, to minimize the dimensions of the main body (and therefore of the overall device), with the same section of the ducts, and, on the other hand, to reduce the number of components necessary to make the dispensing device, simplifying the structure thereof (with advantages in terms of production costs and/or reliability to breakage) and synergistically favouring the miniaturization of the overall device.

On the contrary, the known dispensing devices provide for a pressurization duct obtained (at least in the portion thereof with a longitudinal component) within the thickness of the main body, or made from a further tubular body (distinct from the one dedicated to transferring the liquid) passing through the main body, with consequent complication of the structure and/or greater encumbrance.

The present invention in one or more of the above aspects may have one or more of the following preferred features.

Typically said main body (and said housing seat) has a main longitudinal development direction. Preferably said tubular body has a main longitudinal development direction.

Preferably said adapter comprises a coupling section arranged on the opposite side of said adapter with respect to said main body. In this way it is possible to couple the dispensing device and the container in a simple way.

Preferably said adapter is structured to rotate with respect to said main body about said longitudinal axis. In this way it is possible to couple the adapter to the mouth of the container without the rest of the device following the rotation.

Preferably, said dispensing device comprises a stop element which engages said second mouth of said main body for removably fixing said tubular body to said main body.

Preferably said tubular body protrudes from said first mouth beyond said adapter and/or protrudes from said second mouth of the main body. This simplifies the transfer system.

Typically said tubular body has a transversal dimension (e.g., a diameter) much smaller (e.g., at least five times, preferably at least ten times, even more preferably at least twenty times) than a respective longitudinal length.

Preferably said tubular body is a single body which passes entirely and longitudinally (at least) through said housing seat. This simplifies the structure of the device.

Preferably said tubular body (and said transfer duct), and/or said pressurization duct, has a constant section moving longitudinally. Preferably said outer surface of the tubular body (and more preferably also an inner surface of the tubular body defining said transfer duct) has a circular shape in section. Preferably said tubular body (when undeformed) has cylindrical symmetry with respect to said longitudinal axis. In this way the overall structure of the device is particularly simple.

Preferably said pressurization duct has an entirely longitudinal development. In one embodiment, said pressurization duct is defined by a groove (or by a crown portion) obtained on said inner surface of the housing seat.

Preferably, in a cross section, said pressurization duct subtends (with continuity) a central angle greater than or equal to 30°, more preferably greater than or equal to 60°, even more preferably greater than or equal to 90° (or preferably greater or equal to 180°). In this way, the pressurization duct has an area in section such that it allows the passage of a sufficient volume of gas for the pressurization of the liquid, while keeping the transversal encumbrance limited.

In a particularly preferred embodiment, said central angle is equal to 360°. In other words, the pressurization duct completely surrounds the tubular body with continuity. In this way, in addition to allowing the passage of a sufficient volume of gas, the pressurization duct is made in an industrially simple and/or rapid way (e.g., by means of a single cylindrical milling on the inner surface of the main body).

Preferably said pressurization duct has a three-dimensional tubular shape.

Preferably, in a cross section, a distance between said inner surface of the main body and said outer surface of the tubular body at said pressurization duct (this distance representing a transversal, or radial, depth of the duct) is constant over the entire section. Preferably this distance is greater than 0.10 mm, more preferably greater than or equal to 0.15mm, even more preferably greater than or equal to 0.20 mm (e.g. equal to 0.25 mm), and/or less than 1.0 mm. This distance, typically greater than the mechanical play necessary for the insertion of the tubular body inside the housing seat, forms a duct having sufficient depth, albeit advantageously miniaturized.

Preferably said main body (with the exception of said opening), and/or said housing seat, and/or said pressurization duct, has cylindrical symmetry with respect to said longitudinal axis. Preferably said housing seat has a circular shape in section.

Preferably, at said pressurization duct, a diameter of said housing seat is greater than a diameter of said tubular body (the difference being preferably equal to double the aforementioned distance). In other words, the pressurization duct has the shape in section of a crown segment or a complete crown (depending on the aforesaid angle subtended at the centre). In this way the device is simple in structure and assembly.

Preferably a difference between an area of a section (more preferably between a diameter) of said housing seat and an area of a section (more preferably a diameter) of said tubular body at the pressurization duct is greater than said difference at a longitudinal portion of said housing seat interposed between said pressurization opening and said second mouth of the main body. Preferably, in a cross section, a distance between said inner surface of the main body and said outer surface of the tubular body at said longitudinal portion of the housing seat is constant over the entire section, and preferably less than or equal to 0.10 mm. This distance (or clearance) favours the insertion to size of the tubular body inside the housing seat, favouring the centring of the tubular body with respect to the seat, the correct gas sealing and the correct realization of the pressurization duct.

Preferably said pressurization opening has a transversal, more preferably radial, development. Preferably said pressurization opening puts in fluid communication said housing seat (at one end of said pressurization duct) with said external environment. Preferably said pressurization opening juts into the external environment at a pressurization mouth interposed between said adapter and said second mouth, more preferably on an outer lateral surface of said main body.

Preferably said tubular body and/or said main body and/or said adapter is made of polymeric material (e.g., PET), more preferably suitable for contact with food.

Preferably said dispensing device comprises a further pressurization duct which puts in fluid communication said first mouth of the main body with a further pressurization opening, distinct from said pressurization opening (and from said second mouth), obtained in said main body and jutting into said external environment, wherein said further pressurization duct is part of said housing seat and is defined by the outer surface of the tubular body and the inner surface of the main body. In this way the further pressurization opening provides a further point of access to the housing seat of the main body, in fluid communication with the first mouth (i.e. with the inside of the container).

Preferably said further pressurization duct and/or said further pressurization opening have one or more of the aforementioned characteristics respectively of the pressurization duct and of the pressurization opening. Preferably said further pressurization opening is located in a position transversely (or radially) opposite to said pressurization opening. In this way the openings of the main body are arranged rationally.

Preferably said dispensing device has a first symmetry plane passing through said longitudinal axis, said pressurization opening and said further pressurization opening being at opposite sides of said first symmetry plane. Preferably said dispensing device has a second symmetry plane passing through said longitudinal axis and perpendicular to said first symmetry plane.

Preferably said further pressurization duct coincides with said pressurization duct (in particular in the aforementioned embodiment in which said central angle is at least 180°, for example equal to 360°). This simplifies the device.

In an alternative embodiment said further pressurization duct is distinct from said pressurization duct, for example when both are defined in cross section by a respective crown segment with an angle subtended at the centre of less than 180°.

According to one aspect, the invention concerns a system for transferring a liquid (which can be a system for tapping the liquid from the container and/or a system for filling the container with the liquid, as explained below) comprising:
the dispensing device according to any embodiment of the present invention;
a vessel containing a gas under pressure connected to said pressurization opening;
a transfer line connected to said transfer duct on the side of the second mouth; and
a tap positioned along said transfer line.

In this way it is possible to place the inside of the vessel under pressure through the pressurization duct and to regulate the inlet and/or outlet of the liquid via the tap.

Preferably said transfer line coincides with said transfer duct (i.e. a single body realizes both the transfer duct and the transfer line). In this way the overall structure of the transfer system is simplified.

According to one aspect, the transfer system is a system for filling the container with liquid, where said dispensing device also comprises said further pressurization duct and said further pressurization opening, and where the system further comprises:
a pressurization line arranged to connect said vessel with said pressurization opening;
a first valve arranged along said pressurization line; and
a second valve connected to said further pressurization opening (to regulate a vent of the gas in the container).

Preferably the transfer system comprises a further dispensing device according to the present invention in any embodiment wherein the further dispensing device also comprises a respective further pressurization opening, wherein said pressurization line comprises a first stretch which connects said vessel containing the gas under pressure to said respective pressurization opening of the further dispensing device and a second stretch which connects said respective further pressurization opening of the further dispensing device to said pressurization opening of the dispensing device, wherein said first valve is arranged along said second stretch of the pressurization line, and wherein said transfer line connects said respective tubular body of the further dispensing device to said tubular body of the dispensing device.

Preferably a further valve is also arranged along said first stretch of the pressurization line.

### BRIEF DESCRIPTION OF THE FIGURES

FIG. 1 schematically shows and not to scale a dispensing device according to the present invention coupled to a container;

FIG. 2 shows an exploded view of the dispensing device of FIG. 1;

FIG. 3 schematically shows a longitudinal sectional view of the dispensing device of FIG. 1;

FIG. 3a schematically shows an enlargement of a detail of FIG. 3;

FIG. 4 shows schematically and in a partial way and not to scale a cross section taken along the cutting line A-A in FIG. 3;

FIG. 5 schematically and partially shows a tapping system according to an embodiment of the present invention;

FIG. 6 schematically and partially shows a filling system according to an embodiment of the present invention;

FIG. 7 schematically and partially shows a filling system according to a further embodiment of the present invention.

### DETAILED DESCRIPTION OF PREFERRED EMBODIMENTS OF THE INVENTION

The characteristics and advantages of the present invention will be further clarified by the following detailed description of some embodiments of the present invention, presented by way of non-limiting example, with reference to the attached figures.

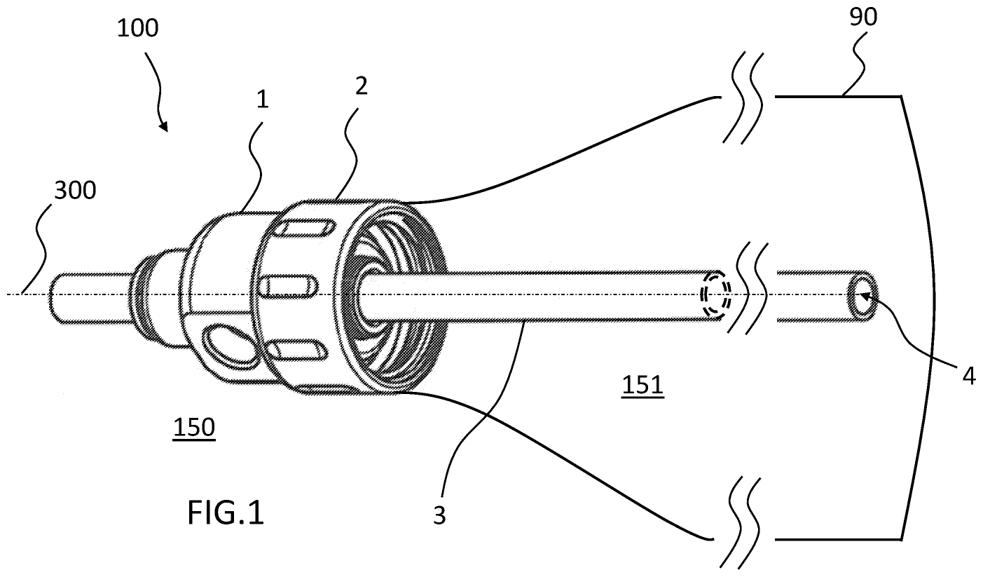

In the figures, reference number 100 indicates a dispensing device for a container 90 of liquids according to the present invention. An example of this dispensing device 100 is described below, with reference to FIGS. 1-4.

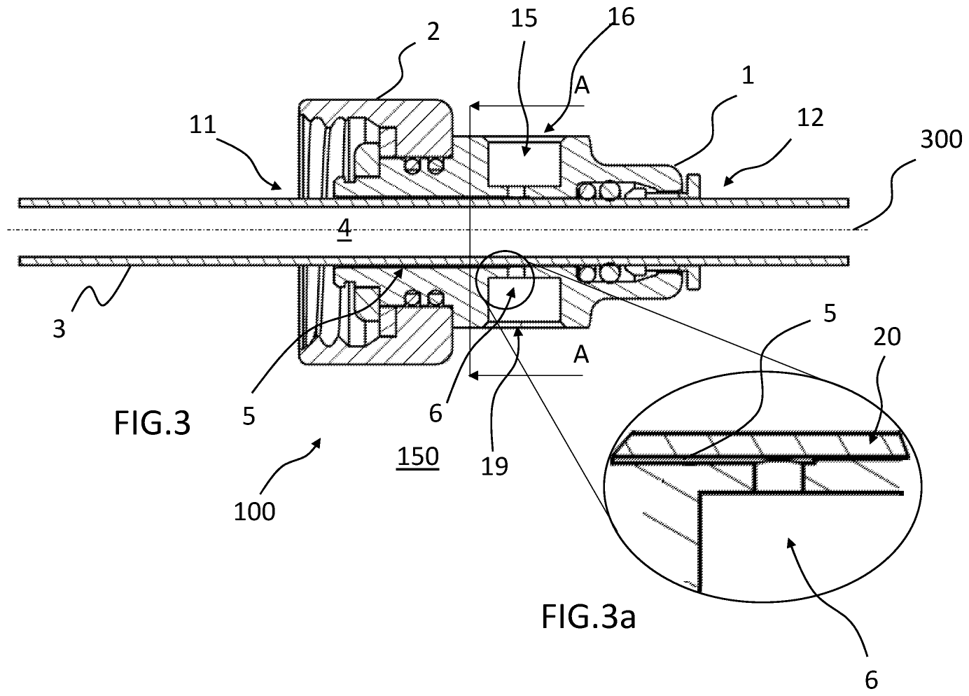

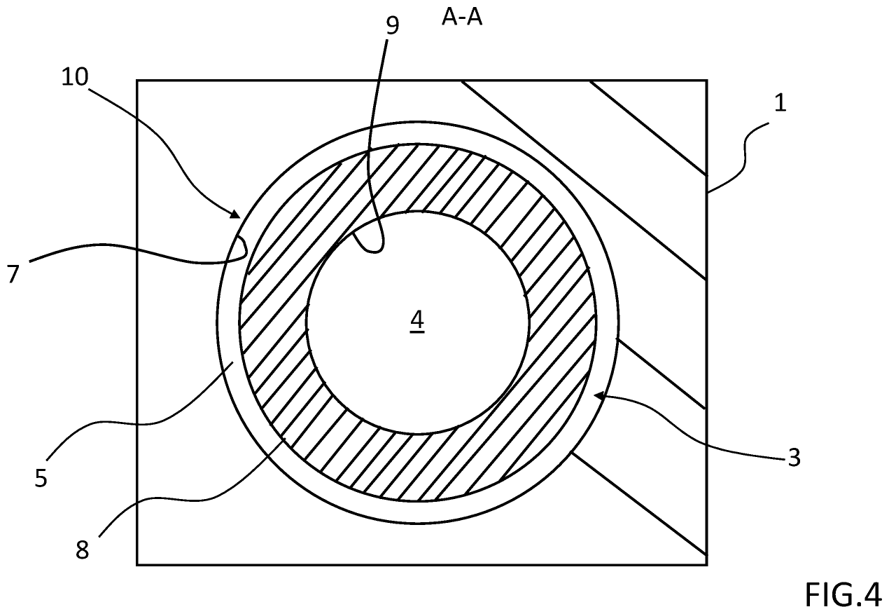

The dispensing device 100 comprises a main body 1 provided with an inner surface 7 (FIG. 4) which defines a housing seat 10 passing from a first 11 to a second mouth 12 (FIG. 3) of the main body 1 arranged along a longitudinal axis 300. In other words, the main body 1 has a longitudinally through cavity.

Exemplarily, the main body 1 and the housing seat 10 have a main development direction along the longitudinal axis 300. Furthermore, the housing seat 10 has exemplarily cylindrical symmetry with respect to the longitudinal axis 300 (i.e., circular shape in cross section).

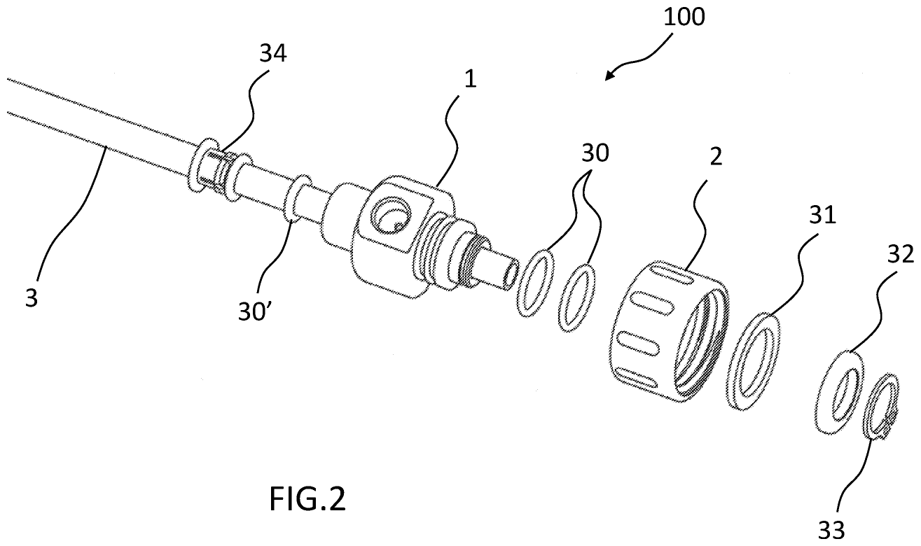

The dispensing device 100 also comprises an adapter 2 coupled to the main body 1 at the first mouth 11 of the main body 1. For example, the coupling between adapter 2 and main body 1 takes place through suitable abutment elements 31, 32 and a stop ring 33, for example of the Seeger type (shown only in FIG. 2) which engages a suitable groove on the main body. Alternatively, this coupling can take place through any other known coupling means, such as for example other types of stop rings (e.g., Benzing ring) or other types of fixings (e.g., split pin).

The adapter 2 is shaped to couple sealingly with a mouth of the container 90. The adapter 2 in fact comprises a coupling section whose structure depends on the specific structure of the mouth of the container 90 to which the dispensing device 100 will have to couple. For example, as exemplarily shown in FIGS. 1-3, the coupling section has an inner thread adapted to rotationally mesh in a respective outer thread of the mouth of the container 90 (as typically present in plastic containers, such as for example a classic bottle). Alternatively (not shown), the coupling section can have a structure adapted to couple with glass containers closed by means of a crown cap (e.g., classic bottles for example of beer or wine) or with containers having an inner thread at the mouth.

Exemplarily, the adapter 2 is structured to rotate with respect to the main body 1 around the longitudinal axis 300 (so as to simplify the coupling of the dispensing device 100 with the container 90). The rotation allows the container to be coupled and/or removed, leaving the dispensing device 100 mounted in the appropriate transfer system. This relative rotation between adapter 2 and main body 1 is favoured by the presence of two O-rings 30 (FIGS. 2 and 3) which, in addition to acting as sealing elements (for both gas and liquid) between adapter 2 and main body 1, slide during the aforementioned relative rotation.

Exemplarily, both the main body 1 and the adapter 2 are made of polymeric material suitable for contact with food, such as for example PET or HDPE.

The dispensing device 100 also comprises a tubular body 3 removably housed in the housing seat 10 and internally defining a transfer duct 4 which puts in fluid communication the first mouth 11 and the second mouth 12 of the main body 1. Exemplarily, the tubular body 3 protrudes from the first mouth 11 beyond the adapter 2 and protrudes from the second mouth 12 of the main body 1.

Exemplarily, the tubular body 3 is a single body and entirely and longitudinally passes through the housing seat 10. Furthermore, the tubular body 3 exemplarily has a longitudinal main development direction (i.e., length).

Exemplarily, the tubular body 3 is flexible and made of polymeric material suitable for contact with food, for example PET or HDPE.

Exemplarily, the tubular body 3 and the transfer duct 4 have a constant section moving longitudinally, and exemplarily both an outer surface 8 and an inner surface 9 (which defines the transfer duct 4) of the tubular body 3 have a circular shape in section (as shown in FIG. 4). Exemplarily, the tubular body 3 has a diameter at least twenty times smaller than a respective length.

In other words, the tubular body is a simple flexible plastic tube.

Alternatively (not shown), the outer and/or inner surface of the tubular body may have a different sectional shape, for example square or rectangular. The housing seat typically has the same shape in section as the outer surface of the tubular body (for purposes of rational housing of the tubular body).

Exemplarily, the dispensing device 100 comprises a stop element 34 which engages the second mouth 12 of the main body 1 for removably fixing the tubular body 3 to the main body 1. Exemplarily, the stop element 34 comprises a respective hollow and elastically deformable main body inside which the tubular body 3 is inserted to size. The stop element 34 further comprises a plurality of (for example four) hooking elements (not shown) protruding from the respective main body, which, when the stop element 34 moves away from the second mouth 12, dragged for example by the tubular body 3, thanks to the elastic deformation of the respective main body, grip the tubular body 3 limiting, or preventing, its longitudinal and/or transversal movement.

Exemplarily, the dispensing device 100 comprises at the second mouth 12 one or more additional sealing elements 30′ fitted onto the tubular body for gas and liquid sealing between the tubular body 3 and the main body 1 (in the example two O-rings, to limit the bending of the tubular body which could compromise the seal).

The dispensing device 100 comprises a pressurization duct 5 (shown in FIGS. 3, 3a, and in section in FIG. 4) which puts in fluid communication the first mouth 11 of the main body 1 with a pressurization opening 6. Exemplarily, the pressurization opening 6 has a radial development, i.e., perpendicular to the longitudinal axis 300 and passing through this axis.

The pressurization opening 6 is obtained in the main body 1, for example through a wall of the main body 1, and juts into an external environment 150 to the dispensing device 100, for example at a pressurization mouth 19 on the outer lateral surface of the main body, in a position interposed between the adapter 2 and the second mouth 12.

As shown in FIG. 4, the pressurization duct 5 is part of the housing seat 10 and is defined (i.e. delimited) by the outer surface 8 of the tubular body 3 and by the inner surface 7 of the main body 1. Exemplarily, in a section transversal to the longitudinal axis 300 (FIG. 4), the pressurization duct 5 continuously subtends a central angle equal to 360°.

Therefore, given the circular shape in cross section of the housing seat 10 and of the tubular body 3 as described above, the pressurization duct 5 has the shape (in cross section) of a complete circular crown, which is constant moving longitudinally (i.e. it has a three-dimensional tubular shape). In other words, in a cross section such as the one shown in FIG. 4, a sectional area (transverse) of the pressurization duct 5 is given by the difference between the sectional area of the housing seat 10 and the sectional area of the tubular body 3 (with reference to the outer surface 8).

Exemplarily, at the pressurization duct 5, a difference (equal to the radial depth of the pressurization duct 5) between the diameter of the housing seat 10 and the diameter (of the outer surface 8) of the tubular body 3 is equal to approximately 0.50 mm (for example the housing seat 10 has a diameter equal to approximately 8.50 mm and the tubular body 3 has a diameter equal to approximately 8.00 mm).

It should be noted that the dimensional values described are to be understood net of manufacturing tolerances.

Exemplarily (FIG. 3), at a longitudinal portion 20 of the housing seat 10 interposed between the pressurization opening 6 and the second mouth 12 of the main body 1, the difference between the diameter of the housing seat 10 and the diameter of the tubular body 3 is less than this difference at the pressurization duct 5, for example it is less than or equal to about 0.10 mm. In other words, while the tubular body 3 has a constant section (or diameter) moving longitudinally, the section (or diameter) of the housing seat varies moving along the longitudinal direction. For example, the diameter of the housing seat is equal to approximately 8.50 mm at the longitudinal portion of the housing seat which runs from the first mouth 11 to the pressurization opening 6, and equal to approximately 8.10 mm at the longitudinal portion 20. The longitudinal portion 20 as described above favours the centring of the tubular body 3 with respect to the housing seat 10.

Exemplarily, the same tubular-shaped pressurization duct 5 puts in fluid communication the first mouth 11 of the main body 1 also with a further pressurization opening 15, distinct from the pressurization opening 6 and from the second mouth 12. The further pressurization opening 15 is obtained in the main body 1, for example in a position diametrically opposite to the pressurization opening 6, and juts into the external environment 150 at a respective pressurization mouth 16 interposed between the adapter 2 and the second mouth 12 on the outer lateral surface of the main body. The dispensing device 100 preferably has a first symmetry plane passing through the longitudinal axis 300 and perpendicular to the plane of FIG. 3 and a second symmetry plane passing through the longitudinal axis 300 and perpendicular to the first symmetry plane (i.e. coinciding with the plan of FIG. 3).

In an embodiment not shown, the pressurization duct in cross section can subtend with continuity a central angle of less than 180°, for example equal to 90° (in other words, the pressurization duct can be in section a segment of a circular crown equal to a quarter of the entire circular crown). In this embodiment, the dispensing device exemplarily comprises a further pressurization duct, distinct from the pressurization duct, which puts in fluid communication the first mouth of the main body with the further pressurization opening. The further pressurization duct is also part of the housing seat and is also defined by the outer surface of the tubular body and the inner surface of the main body.

Exemplarily, the further pressure duct is symmetrical to the pressurization duct with respect to the longitudinal axis.

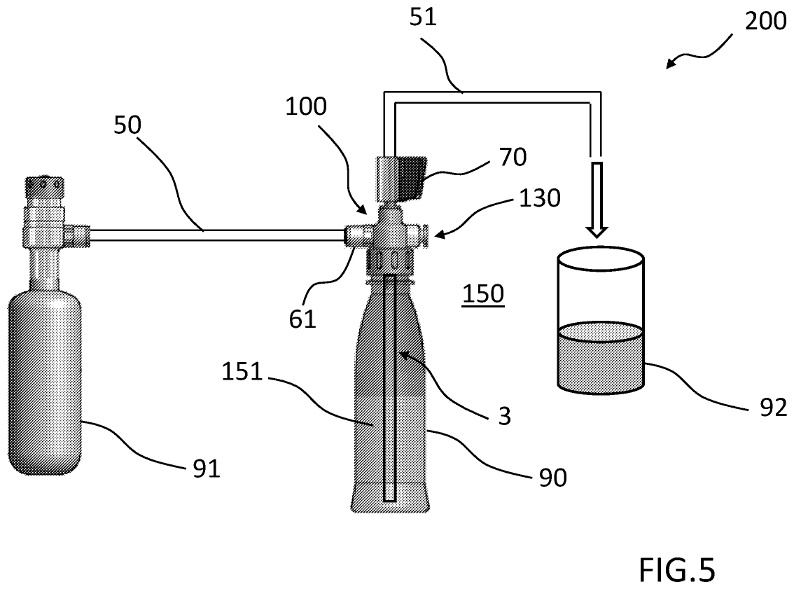

With reference now to FIGS. 5-7, the application of the dispensing device described above in a transfer system is described, which can be a tapping system and/or a filling system.

FIG. 5 schematically shows a tapping system 200 for tapping a liquid according to the present invention comprising the dispensing device 100 described above. Typically for the tapping to be carried out, the further pressurization opening described above is not necessary and, if present, is plugged by means of a suitable element 130. Alternatively (not shown), the tapping system can also comprise a dispensing device according to the present invention without the further pressurization opening.

The tapping system 200 comprises a vessel 91 containing a gas under pressure (for example CO2 or nitrogen) and connected to the pressurization opening 6 (on which a connection element 61 is mounted at the pressurization mouth 19), for example via a pressurization line 50 (for example a physical pipe). In an embodiment not shown, the vessel 91 can be a can of the disposable type directly connected to the pressurization mouth 19 (e.g. after the coupling of the container 90).

The tapping system 200 also comprises a transfer line 51 connected to the tubular body 3 (and to the transfer duct 4) of the dispensing device 100 on the side of the second mouth 12, and exemplarily made as a single piece from the tubular body 3 which protrudes beyond the second mouth 12, and a tap 70 positioned along the transfer line 51.

In use, the dispensing device 100 is hermetically coupled (through the adapter 2) with a liquid-filled container 90 (e.g., a drum, barrel or bottle as shown in FIG. 5), such that the dispensing device seals off (except for the ducts) an internal environment 151 of the container from an external environment 150 of the container, where the first mouth 11 of the main body 1 faces the internal environment 151. The portion of the tubular body 3 which protrudes beyond the first mouth 11 is inserted into the inner space 151 of the container 90 up (substantially) to the bottom of the container 90 so that an end mouth of the tubular body 3 can draw the liquid.

The introduction of the gas into the internal environment 151 of the container 90, through the pressurization line 50, the pressurization opening 6 and the pressurization duct 5 puts the liquid under pressure. At this point, by opening (for example manually) the tap 70 it is possible to let the pressurized liquid flow into the transfer duct 4 of the tubular body 3 (through the aforementioned end mouth of the tubular body) and from here along the transfer line 51, in order to fill a further container 92 (for example a bottle or a glass) placed downstream of an outlet mouth of the transfer line 51.

In an embodiment not shown, a valve is arranged along the line 50 and the tap 70 is not provided along the transfer line 51, so as to allow the container 90 to be removed without gas escaping from the vessel 91.

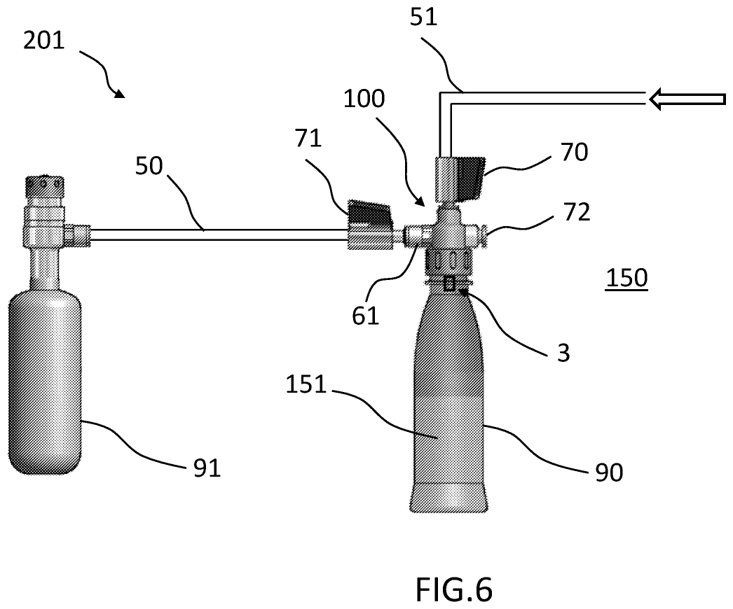

FIG. 6 schematically shows a system 201 for filling a container 90 with a liquid according to the present invention which comprises the dispensing device 100 described above. Typically for the filling to be carried out, it is advantageous for the dispensing device to have the further pressurization opening. The filling system 201 comprises the elements described above for the tapping system 200 and furthermore also comprises:
a first valve 71 arranged along the pressurization line 50;
a second valve 72 (e.g. a tap) connected to the further pressurization opening. In this way it is possible to regulate a venting of the gas which from the internal environment 151 of the container can escape into the external environment 150 through the pressurization duct 5 (which acts as a further pressurization duct).

Typically for the filling to be carried out, it is sufficient for the tubular body 3 to be inserted into the inner volume of the container 90 for even a minimal stretch (e.g., just beyond the mouth of the container).

Exemplarily, the transfer line 51 (which in this case acts as a filling line, i.e. it carries the liquid towards the container 90) transports a liquid (for example pressurized) for filling the container 90.

The filling operation involves the following steps, carried out in chronological order:
coupling the empty container 90 to the device 100 with the tap 70 closed and the second valve 72 closed;
opening the first valve 71 to fill the container 90 with gas (preferably at a pressure equal to or higher than the pressure of the liquid in the transfer line 51) and, at the end of the gas introduction, closing the first valve 71;
opening the tap 70;
opening the second valve 72 to let the gas escape towards the external environment 150 and at the same time to make the liquid flow (under pressure) in the transfer line 51 (in the direction of the arrow in FIG. 6) and introduce this liquid into the container 90 (preferably the pressure in the container 90 is substantially equal to the liquid inlet pressure).

The Applicant has observed that in this way oxidation of the liquid (which does not come into contact with the air) is avoided and, in the case of carbonated beverages, the formation of foam is limited.

As an alternative to the above, it is also possible to carry out the filling using a dispensing device without the further pressurization opening. In this case, the filling involves, after filling the container 90 with the gas, closing the pressurization opening and removing the pressurization line 50 (and of the vessel 91), so that the gas introduced does not escape from the container. At this point it is possible to make use of the pressurization opening as explained above, i.e. as a vent towards the external environment 150, for example by acting on the valve 71.

It should also be noted that the system 201 can also be suitably used as a tapping system (provided that the tubular body 3 draws on the bottom of the container 90).

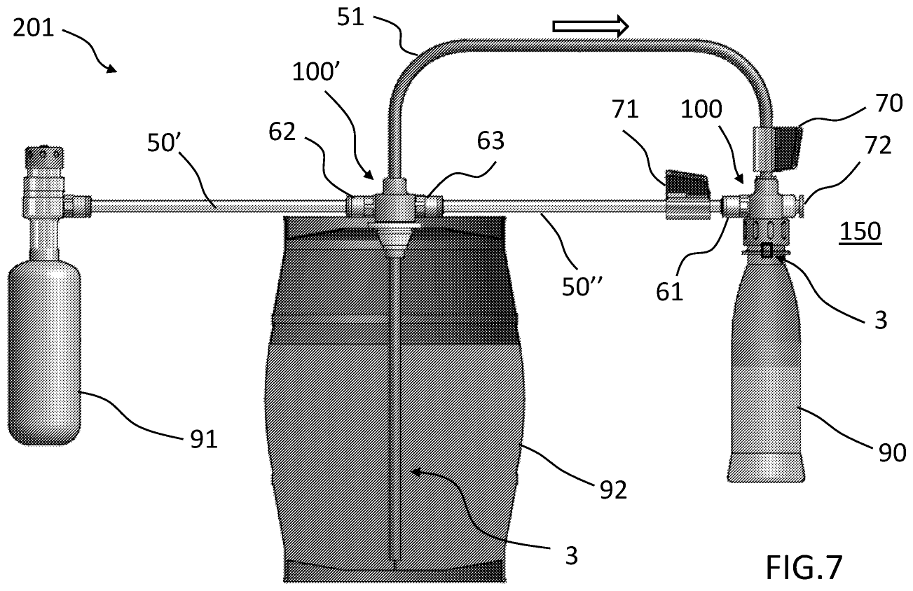

FIG. 7 schematically shows an embodiment in which the filling system 201 comprises a further dispensing device 100′ coupled to a container 92 filled with liquid. The further dispensing device 100′ has an exemplary structure similar to that of the dispensing device 100 described above (although it may differ in shape and/or dimensions, for example to adapt to the mouth of the container 92). In fact, in this embodiment, the dispensing device 100 functions as explained above in relation to filling and the further dispensing device 100′ functions as explained above for tapping.

The fittings 62 and 63 are coupled at the pressurization mouths of the further dispensing device 100′ at respectively the pressurization opening 6 and the further pressurization opening 15 of the further dispensing device 100′. The vessel 91 containing the gas under pressure is connected to the pressurization opening 6 of the further dispensing device 100′ via a first stretch 50′ of the pressurization line 50, e.g., a tube arranged between the two fittings 60 and 62.

Preferably, a further valve or tap (not shown) is positioned along the stretch 50′ to regulate the gas flow.

A second stretch 50″ (e.g. a tube) of the pressurization line 50 connects the further pressurization opening 15 of the further dispensing device 100′ (e.g., via the fitting 63) to the pressurization opening 6 of the dispensing device 100 (e.g., via connection 61). The valve 71 is arranged along the second stretch 50″.

The transfer line 51 connects the respective tubular body of the further dispensing device 100′ to the tubular body of the dispensing device 100. In other words, a single physical pipe is provided which connects the two inner environments of the containers 90 and 92.

The container 90 is filled as explained below. The gas from the vessel 91 flows into the container 92 pressurizing the liquid that enters the transfer line 51. The opening of the valve 71 allows the passage of the gas also in the second stretch 50″ of the pressurization line 50 for the introduction of gas also in the container 90 (this guarantees the same pressure in the two containers). At this point, after closure of the valve 71, the opening of the tap 70 and of the valve 72 allows the venting of the gas and the filling of the container 90 with the liquid, as explained above.

1. A dispensing device for a container of liquids, wherein said dispensing device comprises:
a main body provided with an inner surface which defines a through housing seat from a first to a second mouth of the main body arranged along a longitudinal axis;
an adapter coupled to said main body at the first mouth of said main body, and shaped to couple with a mouth of said container;
a tubular body housed in said housing seat and internally defining a transfer duct which puts in fluid communication said first and said second mouth of the main body;
a pressurization duct which puts in fluid communication said first mouth of the main body with a pressurization opening obtained in said main body and jutting into an external environment to said dispensing device, wherein said pressurization duct is part of said housing seat and is defined by an outer surface of the tubular body and by said inner surface of the main body.

2. The dispensing device according to claim 1, wherein said pressurization duct has a constant section moving longitudinally, wherein, in a cross section to the longitudinal axis, said pressurization duct continuously subtends a central angle greater than or equal to 30°, and wherein said pressurization opening has transversal development and juts into the external environment at a pressurization mouth interposed between said adapter and said second mouth.

3. The dispensing device according to claim 1, wherein said tubular body is a single body which entirely and longitudinally crosses said housing seat, wherein said tubular body and said transfer duct have a constant section moving longitudinally, and wherein said outer surface of the tubular body, an inner surface of the tubular body defining said transfer duct, and said housing seat have a circular shape in section.

4. The dispensing device according to claim 1, wherein, in a cross section, a distance between said inner surface of the main body and said outer surface of the tubular body at said pressurization duct is constant and greater than or equal to 0.15 and less than 1.0 mm, and wherein said distance at a longitudinal portion of the housing seat interposed between said pressurization opening and said second mouth of the main body is constant and less than or equal to 0.10 mm.

5. The dispensing device according to claim 1, wherein said adapter is structured for rotating with respect to said main body about said longitudinal axis, and wherein said dispensing device comprises a stop element which engages said second mouth of said main body) for removably fixing said tubular body to said main body.

6. The dispensing device according to claim 1, comprising a further pressurization duct which puts in fluid communication said first mouth of the main body with a further pressurization opening, distinct from said pressurization opening, obtained in said main body and jutting into said external environment, wherein said further pressurization duct is part of said housing seat and is defined by the outer surface of the tubular body and the inner surface of the main body.

7. The dispensing device according to claim 6, having:
a first symmetry plane passing through said longitudinal axis, said pressurization opening and said further pressurization opening being at opposite sides of said first symmetry plane;
a second symmetry plane passing through said longitudinal axis and perpendicular to said first symmetry plane,
wherein said further pressurization duct coincides with said pressurization duct, wherein said pressurization duct continuously subtends a central angle equal to 360°, and wherein said pressurization duct has full crown shape in section.

8. A transfer system of a liquid comprising:
the dispensing device according to claim 1;
a vessel containing a gas under pressure connected to said pressurization opening;
a transfer line connected to said transfer duct on the side of the second mouth; and
a tap positioned along said transfer line.

9. The transfer system according to claim 8, said transfer system being a system for filling the container with the liquid, wherein the dispensing device comprises a further pressurization duct which puts in fluid communication said first mouth of the main body with a further pressurization opening, distinct from said pressurization opening, obtained in said main body and jutting into said external environment, wherein said further pressurization duct is part of said housing seat and is defined by the outer surface of the tubular body and the inner surface of the main body, and wherein the transfer system comprises:
a pressurization line arranged to connect said vessel with said pressurization opening;
a first valve arranged along said pressurization line; and
a second valve connected to said further pressurization opening.

10. The transfer system according to claim 9, comprising a further dispensing device comprising a further pressurization duct which puts in fluid communication said first mouth of the main body with a further pressurization opening, distinct from said pressurization opening, obtained in said main body and jutting into said external environment, wherein said further pressurization duct is part of said housing seat and is defined by the outer surface of the tubular body and the inner surface of the main body, wherein said pressurization line comprises a first stretch which connects said vessel to a pressurization opening of the further dispensing device and a second stretch which connects a further pressurization opening of the further dispensing device to said pressurization opening of the dispensing device, wherein said first valve is arranged along said second stretch of the pressurization line, and wherein said transfer line connects a respective tubular body of the further dispensing device to said tubular body of the dispensing device.
